(19) United States
(12) Patent Application Publication
(10) Pub. No.: US 2017/0270200 A1
(43) Pub. Date: Sep. 21, 2017

(54) APPARATUS AND METHOD FOR ACTIVE ACQUISITION OF KEY INFORMATION AND PROVIDING RELATED INFORMATION

(71) Applicant: Marty McGinley, Overland Park, KS (US)

(72) Inventor: Marty McGinley, Overland Park, KS (US)

(21) Appl. No.: 15/617,893

(22) Filed: Jun. 8, 2017

Related U.S. Application Data
(63) Continuation-in-part of application No. 14/496,718, filed on Sep. 25, 2014, now abandoned.

(51) Int. Cl. G06F 17/30; G06F 3/16; G06K 9/00; H04R 1/02; G10L 15/24; G10L 15/22; G10L 15/26

(52) U.S. Cl. CPC G06F 17/30752; G10L 15/22; G06F 3/165; G10L 15/265; H04R 1/028; G10L 15/24; G06K 9/00671; G10L 2015/223; H04R 2499/11

(57) ABSTRACT

An apparatus for automatically providing information related to actively acquired key information is disclosed. The apparatus comprises an input device to actively acquire key information, an output device to provide the related information, a processor, and a memory. The processor is configured to access an information source to search for related information based on the key information, and to receive the found related information. The information source may be stored in the memory, or remotely, or partly in the memory and partly remotely. The processor may be in the same physical device as the input device and the output device, or the processor may be in a separate physical device from the input and output devices.

### CROSS-REFERENCE TO RELATED APPLICATION

This application is a continuation-in-part of and claims priority in U.S. application Ser. No. 14/496,718 filed Sep. 25, 2014, now U.S. Publication No. 2016/0092562, which is incorporated herein by reference.

### BACKGROUND OF THE INVENTION

1. Field of the Invention

The invention relates to apparatuses and methods for the automatic acquisition of key information and the automatic search and provision of information related to the key information.

2. Description of the Related Art

Obtaining up-to-date information is desirable in many circumstances. A person having the latest relevant information in a conversation with another person can carry on a more effective conversation. A salesperson having up-to-date information related to a customer or a potential customer is able to have a more productive conversation with such customer or potential customer. A person in a conversation with an acquaintance can reconnect more meaningfully with up-to-date information related to the acquaintance. When meeting a stranger, a person having up-to-date information related to the stranger is able to have a more natural conversation.

Unfortunately, up-to-date information is often difficult or impractical to obtain. For example, a person preparing to meet a number of people, as a group or individually one after another, can spend some time gathering the latest information about them. The information may be gathered from resources and databases, such as social media sites, web search engines, commercial databases, customer relationship management databases, and sales information databases. Such a time-consuming process requires even more time in a subsequent step to memorize the information prior to meeting the people. In some cases, the information about those people may have to be gathered far in advance of the meeting, resulting in information that may not be up-to-date. In other cases, up-to-date information cannot be obtained in advance, because a person may not or cannot know the identity the persons that he might meet or unexpectedly encounter.

Up-to-date information can be obtained using known methods or devices. For example, a person, upon meeting another person, may obtain the other person's name and then, during the conversation between them, operate a device, such as a smartphone or laptop, to obtain up-to-date information about the other person. However, operating a device in that way to obtain up-to-date information requires manual operation and is disruptive to the conversation. In another example, upon meeting another person, a person may, during the conversation, operate a visibly obtrusive wearable device, such as the Google Glass™ device, to obtain up-to-date information about the other person by providing instructions to the device, so that the device may then respond by presenting the information visually to the person. Again, operating such device in that manner is disruptive, because it requires manually providing instructions or commands. Thus, obtaining up-to-date information in a less obtrusive, less disruptive, and more automated method is desirable. Obtaining such information using a device that is visibly less obtrusive is also desirable.

Up-to-date information may include information in social media concerning a person. For example, that information may include updates and posts by the person to his social media account, and updates and posts about the person by another person in another social media account. Some examples of social media include websites such as facebook.com, twitter.com, and linkedin.com. Up-to-date information may include information concerning a customer, and may be retrieved from data sources such as the World Wide Web, a sales database, or a contact database. Up-to-date information may also include information concerning a patient, and may be retrieved from data sources, such as a health information systems and patient databases.

### BRIEF SUMMARY OF THE INVENTION

Broadly, the disclosed systems, methods, and apparatuses enable information to be automatically provided. The disclosed subject matter relates to actively acquiring key information, and automatically providing information related to that key information. The apparatuses are provided with a processor configured to actively acquire the key information via an input device. In some embodiments, more than one processor is provided and configured. The processor is further configured to automatically provide the information related to the key information (the “related information”). The apparatus is provided with one or more memories, and the key information and the related information are stored in the one or more memories. More specifically, key information is actively acquired, and information sources are accessed and searched to retrieve the related information. The related information includes up-to-date information related to the key information. Further, the related information can be automatically provided to a user using the apparatus.

Some embodiments of the invention include an apparatus for providing information related to key information. The apparatus includes a processor, and actively acquires key information. The processor is configured to access an information source to search for information related to the key information (the “related info”). The apparatus includes a memory for storing the key information and the related information. The apparatus may further include an input device for acquiring the key information and an output device for providing the related information. The processor is further configured to receive the key information from the input device, and to provide the related information to the output device.

In some embodiments, the active acquisition means that the key information is continuously, or substantially continuously, acquired. In some other embodiments, active acquisition means acquiring the key information at periodic intervals, including at regular periodic intervals. In yet other embodiments, the apparatus automatically acquires key information when conditions are met, for example, only when the key information (such as sounds) is detected, or only when changes to the key information (such as changing visual information) are detected.

Embodiments of the key information include sounds, electromagnetic radiation, location information, global positioning system (GPS) information, wireless signal information, motion information, ionization radiation, and atmospheric information. Embodiments of the input device for acquiring the key information include a microphone; a camera; a global positioning system (GPS) receiver; a wireless signal receiver; a thermometer; a humidity sensor; and a barometer. Embodiments of the output device for providing related information include a visual display device; a speaker; a visible indicator; and a haptic feedback device. Embodiments of the information source include social media data; web page sources; a sales database; a contact database; a weather information system; a health information system; a patient database; news information data; a geographic information system; a geographical database; and a vehicle repair database.

The information source, in some cases, is stored remotely from the processor, and in other cases is stored in the memory of the apparatus. Moreover, more than one information source can be provided, and in such case, all sources may be stored together either remotely from the processor or in the memory of the apparatus, or some sources may be stored remotely while others are stored in the memory. The processor can further be configured to access each information source to search that source for information related to the key information and to retrieve the related information. The processor is further configured to access a remotely stored information source either via a wired connection or a wireless connection.

In some embodiments, the processor is further configured to prepare the key information for search. Thus, in the case where the key information includes sounds, the processor is configured to prepare the sounds by applying speech recognition to the sounds to process the sounds for subsequent search. And, in the case where the key information includes visual information such as images, the processor is configured to prepare the visual information by applying pattern recognition to process the visual information for subsequent search. In many cases where the key information includes analog information, the processor is configured to prepare the analog information for subsequent search by converting the analog information to digital data.

According to some embodiments, the input device, the output device, the processor, and the memory are contained in one housing. In some cases, the apparatus further includes a wireless transceiver. The one housing may be a device wearable proximally to the external auditory canal of a person's ear.

In some embodiments, the input and output devices of the apparatus are contained in one housing, such as an ear-bud headphone. The processor may be contained in a housing separate from housing that contains the input and output devices, and can be further configured to receive key information from the input device wirelessly and to provide the related information to the output device wirelessly. Embodiments of the either housing include a wireless device, a laptop, a smartphone, a computer, a server, a mobile device, a tablet computer, and an information storage device.

The input device of the apparatus actively acquires key information, and the types of input devices include a microphone, a camera, a global positioning system (GPS) receiver, a wireless signal receiver, a thermometer, a humidity sensor, and a barometer. The output device of the apparatus provides information related to the key information, and the types of output devices include a visual display device; a speaker; a visible indicator; and a haptic feedback device. The apparatus may further include a processor and a memory, where the processor is configured to communicate with the input device and with the output device. The processor is further configured to access an information source to search for information related to the key information, and to receive the related information found by the search. The processor may be configured to access the information source after only acquiring a threshold quantity of key information. The information source is stored in the memory of the apparatus. The types of information sources include social media data, web page sources, a sales database, a contact database, a weather information system, a health information system, a patient database, news information data, a geographic information system, a geographical database, and a vehicle repair database.

In some cases, the processor of the apparatus is further configured to access another information source to search for other information related to the key information. In one embodiment, the other information source is stored remotely, and the processor is configured to receive the other related information found by the search of the other information source. Once received, the other related information is stored in the memory of the apparatus. Some embodiments of the key information include sounds, electromagnetic radiation, location information, global positioning system (GPS) information, wireless signal information, motion information, ionization radiation, and atmospheric information.

According to some embodiments, the processor is further configured to prepare the key information for search. Thus, in embodiments where the key information includes sounds, the processor is configured to prepare the sounds by using speech recognition to convert the sounds to digital data, such as text. In other embodiments where the key information includes visual information such as images, the processor is configured to prepare the visual information by using pattern recognition to convert the information to digital data, such as a digital image file and/or text. In yet other embodiments, the processor is configured to prepare key information comprising analog information by processing the analog information to digital data.

The information found by the search is provided to the output device. In some embodiments, the input device communicates with the processor via either a wireless connection or a wired connection. In some embodiments, the input device and the output device are housed in one physical device, while in other embodiments, the processor is housed in a device physically separate from the one physical device. Embodiments of the devices include a wireless device, a laptop, a smartphone, a computer, a server, a mobile device, a tablet computer, and an information storage device. According to some embodiments, the input device, the output device, the processor, and the memory are housed in one physical device. In some embodiments, the apparatus further comprises a wireless transceiver. In some of those embodiments, the one physical device comprises a device wearable proximally to the external auditory canal of a person's ear.

According to some embodiments, a method for providing information includes configuring an input device to actively acquire key information, and configuring an output device to provide information related to the key information. Embodiments of the key information include sounds, electromagnetic radiation, location information, global positioning system (GPS) information, wireless signal information, motion information, ionization radiation, and atmospheric information. Embodiments of the input device include a microphone; a camera; a global positioning system (GPS) receiver; a wireless signal receiver; a thermometer; a humidity sensor; and a barometer. Embodiments of the output device include a visual display device; a speaker; a visible indicator; and a haptic feedback device.

In some cases, the method further includes configuring a processor to communicate with the input and output devices, and to access an information source to search for information related to the key information and to receive the related information. Embodiments of information sources include social media data; web page sources; a sales database; a contact database; a weather information system; a health information system; a patient database; news information data; a geographic information system; a geographical database; and a vehicle repair database. In embodiments where the information source is stored remotely, the method further comprises configuring the processor to access the information source via a network connection and to receive the related information via the network connection. Embodiments of the network connection include wired and wireless connections.

The method may further include configuring the processor to prepare the key information for a subsequent search. Thus, in embodiments where the key information comprises sounds, the method comprises configuring the processor to apply speech recognition to the sounds to generate digital data for search. In other embodiments where the key information comprises analog information, the method further comprises configuring the processor to convert the analog information to digital data for search.

In some embodiments, the method further comprises configuring the processor to communicate with the input device and with the output device. The method may include configuring the processor to communicate with the input device via a wireless connection. Likewise, the method may include configuring the processor to communicate with the output device via a wireless connection.

### BRIEF DESCRIPTION OF THE DRAWINGS

The drawings constitute a part of this specification and include exemplary embodiments of the present invention illustrating various objects and features thereof.

FIG. 1 is an illustration of one embodiment of the disclosed subject matter.

FIG. 2 is an in-ear embodiment of the disclosed subject matter.

FIG. 3 is an embodiment having a glasses component and a smartphone component.

FIG. 4 is an embodiment having an in-ear component and a watch component.

FIG. 5 is a flow chart illustration of aspects of the disclosed subject matter.

FIG. 6 is a diagrammatic representation of an embodiment of the present invention showing the relationships between components thereof.

FIG. 7 is a flowchart diagramming the steps taken in practicing an embodiment of the present invention.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning. Additional examples include computing devices such as a mobile smart device including a display device for viewing a typical web browser or user interface will be commonly referred to throughout the following description. The type of device, computer, display, or user interface may vary when practicing an embodiment of the present invention. A computing device could be represented by a desktop personal computer, a laptop computer, “smart” mobile phones, PDAs, tablets, or other handheld computing devices.

### II. Preferred Embodiment

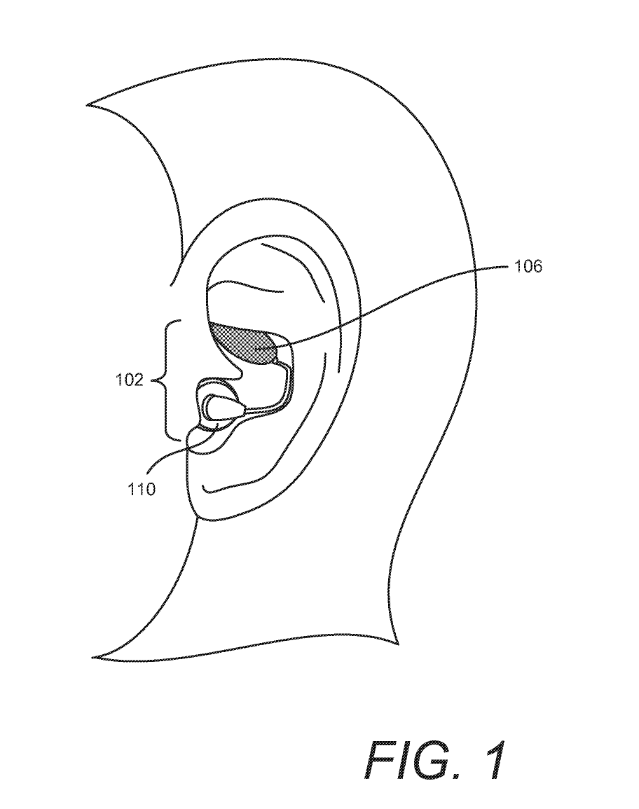

Referring to FIG. 1, an illustration of one embodiment of the disclosed subject matter includes an in-ear apparatus 102, comprising an input device such as a microphone, and an output device 110 such as an ear bud speaker. In this embodiment, the microphone is part of component 106 of the apparatus. Key information, for example, spoken words, is actively acquired by the microphone, and the apparatus 102 accesses and searches information sources, such as social media servers, for information related to the key information.

Although a user may turn the apparatus on or off, active acquisition means that once the apparatus has been turned on, the user does not need to instruct, request, or command the apparatus to begin or to continue acquisition of the key information. Other terms may be used to describe this aspect of the invention, including passive acquisition or automatic acquisition. Thus, the active acquisition of the key information may be considered passive acquisition, because once the apparatus has been turned on, it acquires the information without the user instructing, requesting, or commanding the apparatus to begin or continue the acquisition. Similarly, the acquisition of the key information may be considered automatic acquisition, because when the apparatus is on, it beings or continues acquiring the key information automatically, without the user instructing, requesting, or commanding the apparatus.

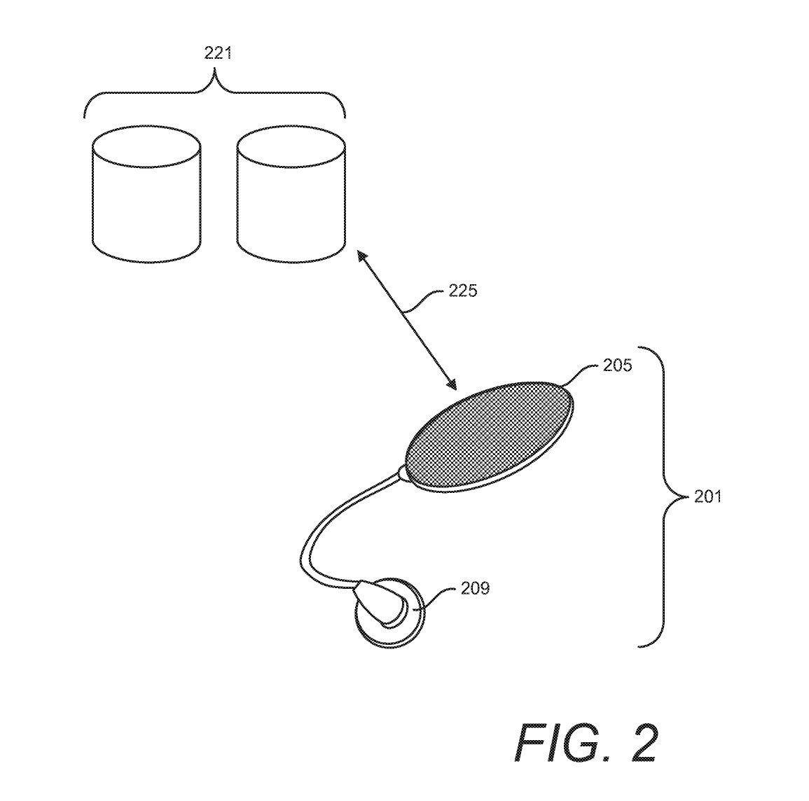

Referring to FIG. 2, in some embodiments, the apparatus 201 actively acquires sounds, such as a person's speech using, for example, a microphone, which in this embodiment is embedded in portion 205 of the apparatus 201. In this embodiment, the apparatus 201 accesses and searches information sources 221 via a wireless connection 225. Because the apparatus 201 actively acquires sounds, a user of the apparatus need not instruct, request, or command the apparatus to acquire, or continue to acquire, the sounds.

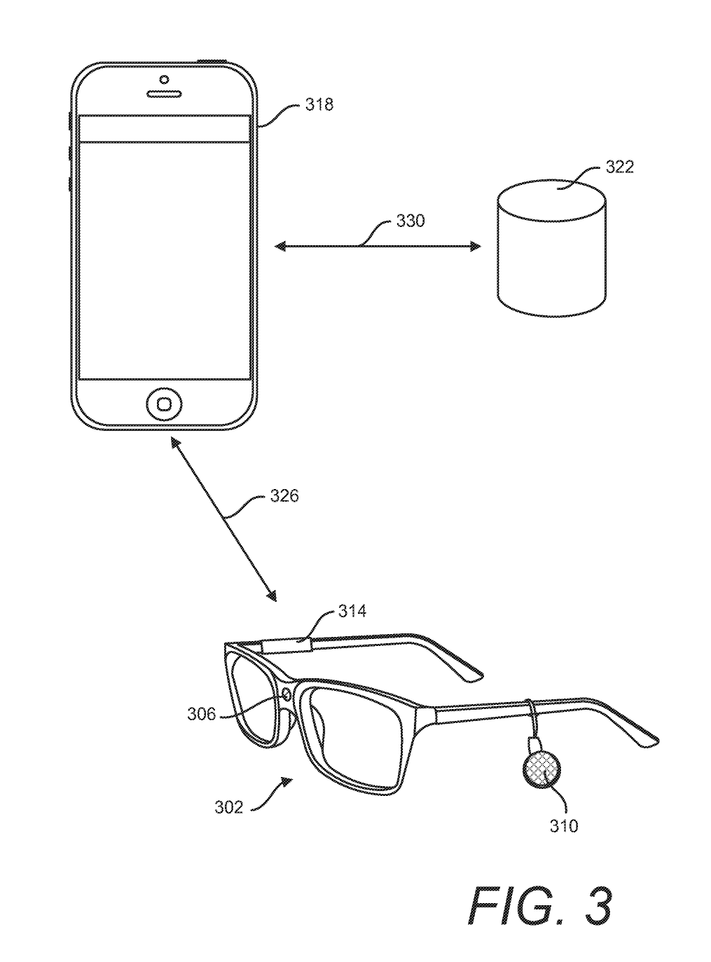

In other embodiments, the apparatus passively acquires visual information, using, e.g., a still camera or a video camera. Referring to FIG. 3, an embodiment of the apparatus includes a wearable component, such as glasses 302, and a processing device 318. Although the processing device 318, in this embodiment, is a smartphone, other embodiments of the processing device 318 include mobile phones, wireless devices, mobile computers, laptop computers, desktop computers, and servers. The wearable component comprises an input device such as a video camera 306, an output device such as an ear-bud speaker 310, and a communications component 314 capable of wireless communications. The smartphone is configured to be in wireless communications 326 with the glasses 302 and to access an information source 322 via wireless communications 330. The information source 322 in this embodiment is located on a remote device, such as a server, but in other embodiments the information source may be located on the processing device 318. The smartphone is further configured to search the information source 322 for information related to the key information. In this embodiment, the information source includes databases that contain information related to the visual information, such as images in a social media database or a police database.

In some embodiments, the active acquisition means that the key information is continuously, or substantially continuously, acquired. In some other embodiments, active acquisition means acquiring the key information at periodic intervals, including at regular periodic intervals. In yet other embodiments, the apparatus automatically acquires key information when conditions are met, for example, only when the key information (such as sounds) is detected, or only when changes to the key information (such as changing visual information) are detected.

Various types of key information may be actively acquired by the disclosed apparatus, including such embodiments as sounds, electromagnetic radiation, location information, global positioning system (GPS) information, wireless signal information, motion information, ionization radiation, and atmospheric information such as temperature, particulate information, gas information, humidity, and pressure. Electromagnetic radiation includes visible light, radio waves, microwaves, infrared light, ultraviolet light, x-rays, and gamma-rays. The different types of input devices necessary to acquire the various embodiments of key information often consists of sensors, and include such embodiments as microphones, cameras, infrared sensors, ultrasound microphones, thermometer, GPS receiver, motion sensor, accelerometer, barometer, Geiger counter, smoke detectors, echo-locators, camera arrays for acquiring 3D information, etc. Other embodiments of key information not expressly recited herein may be actively acquired using other embodiments of input devices, whether or not expressly recited herein, without departing from the scope of this disclosure.

In some embodiments, the key information is processed by the apparatus for use with a subsequent search. In one example, key information comprising sounds is processed to recognize speech using speech recognition techniques. The processing of the sounds produces digital information, such as text, for use with a subsequent search of the information sources. In another example, visual information is processed to recognize patterns, such as objects, persons, text, etc., producing digital information, such as digital images or text, for use with a subsequent search. In some other embodiments, analog information is processed to convert it to digital data for use with a subsequent search.

In some cases, the apparatus is configured to automatically—that is, without any instruction, request, or command from a user—access an information source to search for information related to the key information. The apparatus, for example, may be configured to access the information source as the key information is being acquired. Alternatively, the apparatus may access the information source only after a threshold quantity of the key information has been acquired. The information source that the apparatus accesses may be stored in a memory of the apparatus, in a memory of a remote device, or may be stored partly in the memory of the apparatus and partly in the memory of a remote device.

In another embodiment, the related information found by searching the information sources is provided by the apparatus to a user. Thus, the apparatus, in some embodiments, is configured to automatically retrieve and provide to the output device the related information as it is found by the search. In other embodiments, when related information is found by the search, it is received by the apparatus to automatically provide to the output device. Thus, a user of the apparatus merely needs to turn on the apparatus to enable the apparatus to actively acquire key information, to automatically access and search information sources for information related to the key information, and to automatically retrieve and provide to the user the related information as it is found by the search.

In the example of the in-ear embodiment of FIGS. 1 and 2, a user turns on the apparatus 102, 201, which enables the apparatus to automatically acquire sounds via its microphone without further instruction, request, or command from the user. The sounds may include names of person(s) that may have been spoken in a conversation. The microphone in some embodiments is located in component 106, 205. Once turned on, the apparatus automatically accesses and searches information sources 221 such as social media databases and/or sales information databases for information related to the names of person(s). The apparatus in this embodiment accesses 225 the databases 221 wirelessly. The apparatus also automatically retrieves any information related to the names of persons that was found by the search and to provide that related information to the user via the ear-bud speaker 110, 209.

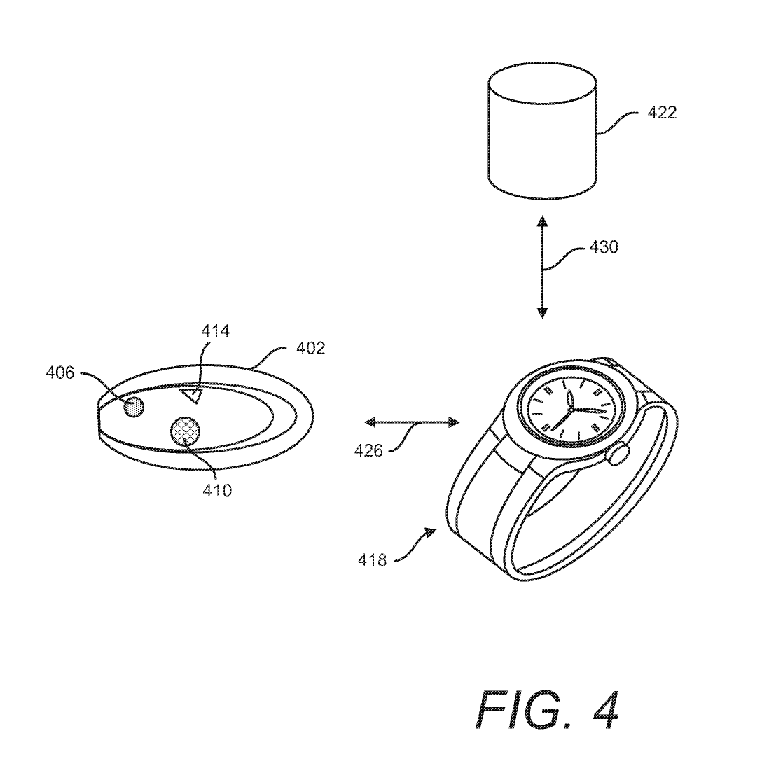

The apparatus may be, in part or in whole, a wearable device, which may be part of a person's wardrobe or accessories. Referring to FIGS. 1 and 2, some embodiments include in-ear pieces 102, 201, over-the-ear headsets, earrings, hair accessories, eyeglasses, and watches. Referring to FIG. 3, the apparatus in some embodiments comprises more than one component, such as eyeglasses 302 in combination with a smartphone 318, or a smartphone in combination with an in-ear piece. Referring to FIG. 4, the apparatus, in some other embodiments, comprises a watch 418 in combination with an in-ear piece 402. The in-ear piece 402 includes an input device microphone 406, an output device speaker 410, and a wireless communication component 414 which communicates wirelessly with watch 418. The watch 418 is configured to wirelessly access the information source 422. Still other embodiments of the apparatus include devices that can be: placed on a person's body or apparel; placed on or in a vehicle, including the vehicle's dashboard; and placed on, at, or near, or affixed to, furniture or an architectural component. Other embodiments may be employed without departing from the scope of those disclosed herein.

The apparatus accesses one or more information sources 221, 322, 422 to search for information related to the key information. Information sources 221, 322, 422 are usually stored on computer readable medium, oftentimes on servers. The types of information sources 221, 322, 422 that the apparatus can access to search for information include social media data; web page sources; a sales database; a contact database; a weather information system; a health information system; a patient database; news information data; a geographic information system; a geographical database; a telephone directory; a dictionary, including foreign language dictionary; a government database; a missing persons database; a sex offender registry; a database of convicts, ex-convicts, and persons sought by the authorities; and a vehicle repair database. Social media data include information from data from LinkedIn, Facebook, and Twitter. Sales databases includes databases related to customers, prospects, potential customers, or former customers, and includes databases associated with commercial sales management software, such as Salesforce.com. Vehicle repair databases include: parts databases and repair procedures information for repair of automobiles, motorcycles, and aircraft. Other embodiments of information sources may be employed without departing from the scope of those disclosed herein.

According to some embodiments, the apparatus provides the related information via an output device. In some cases, the related information is provided via an output device to a user. Referring to FIGS. 1, 2, 3, and 4, embodiments of output devices include: a speaker 110, 209, 310, 410; a visual display device; a visible indicator; a heads-up display; and a haptic feedback device. The output devices perform their common functions--the speaker 110, 209, 310, 410 outputs the related information in audio format. The visual display device comprises a display screen to provide the related information in image or video format. Embodiments of a visible indicator include electrical or electronic means, such as a light or LED that can be turned on and off to provide the related information. Visible indicators also include electromechanical means, such as a mechanical switch, dial, and counter, each configured to provide the related information by indicating a status or message. A heads-up display projects the related information onto a (usually transparent) background. A haptic feedback device outputs forces, vibrations, pressure, or motion, etc. The output device of the apparatus serves to provide related information found by a search, oftentimes to a user. Upon receiving the related information found by a search of information sources, the output device automatically provides the related information, without a user's request, command, or instruction. Other embodiments of the output device may be employed without departing from the scope of those disclosed herein.

In some embodiments of the apparatus, an input device, an output device, and a processing device for accessing the information sources are housed together in a single physical apparatus. In the in-ear apparatus 102, 201 of FIGS. 1 and 2, the input device microphone, the output device ear-bud speaker 110, 209, and the processing device 106, 205 are part of a single physical apparatus. Other embodiments of the apparatus wherein the input device, output device, and processing device are housed in a single physical apparatus include an over-the-ear headset, or a pair of eyeglasses.

In other embodiments of the apparatus, the components of the apparatus may be in separate housings. For example, in FIG. 3, the apparatus comprises a pair of glasses 302 and a smartphone 318. The glasses 302 comprise an input device microphone 306, an output device ear-bud speaker 310, and a wireless communication component 314. The smartphone 318 comprises the processing device, communicates wirelessly 326 with the glasses, and accesses the information source 322 wirelessly 330. In another example, in FIG. 4, the apparatus comprises an in-ear device 402 and a separate watch 418. The in-ear device 402 comprises an input device microphone 406, an output device speaker 410, and a wireless communication component 414. The separate watch 418 comprises the processing device, communicates wirelessly 426 with the in-ear device 402, and accesses an information source 422 wirelessly 430. The wireless communication 225, 326, 330, 426, 430 includes wireless protocols such as Bluetooth, Near Field Communication (NFC), Wi-Fi, cellular, 3G, 4G, HSPA+, WiMAX, LTE, etc.

In yet other embodiments of the apparatus, the input device is housed in one component of the apparatus (for example, an in-car microphone), the output device is housed in a second component (for example, Bluetooth speakers), and the processing device is housed in a third component (for example, a Wi-Fi connected processor such as a smartphone), wherein each device of the apparatus remains in wired or wireless communication with at least one other device. Any of the components may house the processing device that optionally prepares the key information for use with subsequent searches. Other embodiments of the apparatus may be employed without departing from the scope of those disclosed above.

The apparatus can be configured to acquire different types of key information and/or to access alternate information sources. Further, given a type of information source, the apparatus can also be configured to provide certain types of information. For example, the in-ear embodiment 102, 201 may be configured to acquire information by listening for names of persons, to access social media data to search for information related to an acquired name, and to provide via the speaker 110, 209 the related information found by the search. Instead of, or in addition to, accessing social media data, the apparatus may be configured to access a sales information database to search for sales and customer information related to a name of a customer. In another example, the apparatus may be configured to actively listen for locations, such as restaurants and/or addresses, to actively acquire the location of the apparatus via GPS, to search a geographic information database for directions from the location of the apparatus to a restaurant and/or an address, and to provide those directions via the speaker. In some embodiments, the apparatus may be configured by a physical switch on the apparatus to denote which type of key information to acquire or which information source to access. In other embodiments, the apparatus is configured using an application residing in a component of the apparatus, for example, an application residing in a smartphone 318 that is in wired or wireless communications 326 with the glasses component 302.

In some embodiments, the apparatus 102, 201 further comprises a power source, such as a battery, and a switch to power the apparatus on and off. In one embodiment, the switch is a sliding switch, wherein sliding in one direction turns the apparatus on, and sliding in opposite direction turns it off. A person wearing the apparatus may use his finger to slide the switch in the desired direction. When in the powered-on state, the apparatus 102, 201 actively acquires key information without any further instructions, requests, or commands, for example, by actively listening for sounds. The apparatus automatically accesses information resources to search for and retrieve information related to the key information, and automatically provides the found related information via the output device 110, 209. In one feature, the apparatus comprises a mute switch, which turns off only the output device of the apparatus, for example, allowing a user to temporarily disable the audio output.

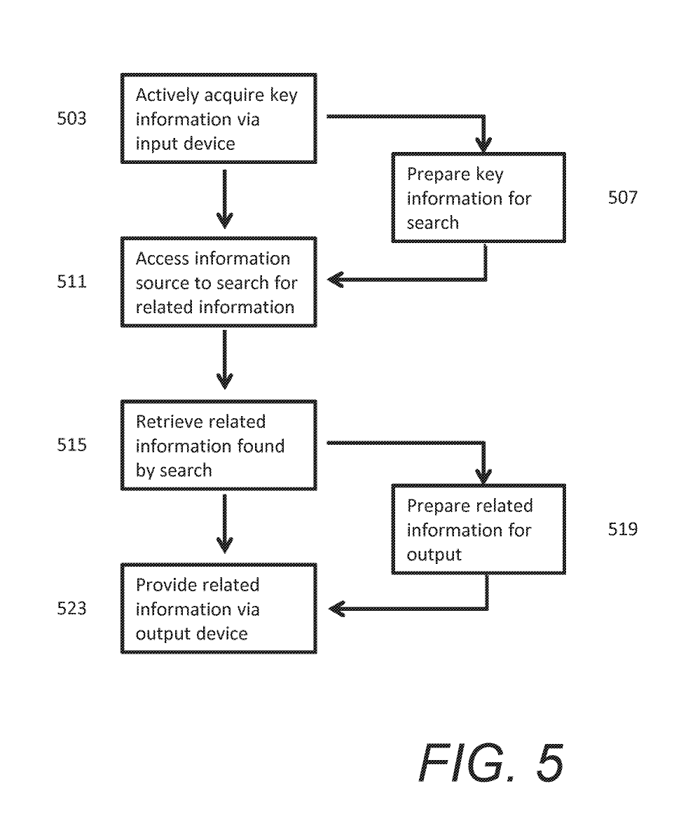

Referring to FIG. 5, the apparatus optionally prepares 507 the key information for use in a subsequent search, for example, by using speech recognition to convert sounds into a digital format, such as text. The apparatus is configurable to search for all of the text, or only names of persons, for example. Whether or not the key information is prepared 507 for search, the apparatus accesses 511 at least one information source to search 511 for information related to the key information, and retrieves 515 the information found by the search. For example, at 511 the apparatus accesses social media data from, for example, the websites of Facebook, LinkedIn, and Twitter, to search for information related to the key information. In that example, the key information may comprise the name of a person and other actively acquired information, and the apparatus searches the social media data for posts by or about the person. The information found by the search is retrieved 515 and provided 523 by the output device of the apparatus, such as a speaker of the in-ear device. So, the apparatus automatically provides a person wearing the in-ear embodiment 102, 201, 402 with information about another person while the two persons are having a conversation. And, in one example, once the in-ear device has been turned on, it actively listens 503 for names of people, optionally prepares 507 the names for search, searches 511 for social media information related to the names, and retrieves 515 and provides 523 the social media information to the user via the in-ear device 102, 201, 402.

Referring to FIG. 5, in some embodiments, after the apparatus retrieves 515 related information found by a search, the apparatus prepares 519 the information found by the search for subsequent output by the output device. In one example, the apparatus includes a camera that actively acquires 503 key information such as images or videos. The apparatus then accesses 511 a database that comprises images of persons sought by law enforcement to search 511 for images in the database that match the acquired images or videos, and to retrieve 515 from the database information related to such matches. The retrieved information may then be prepared 519 for output by the output device 523. In this example, if the retrieved information comprises text information related to the matching image, the apparatus may prepare 519 such text information for output to a speaker 523 by substituting the text with audio representing the text using, for example, speech synthesis. The apparatus is configurable to provide selective output to the output device, for example, to provide only names, events, dates, employers, etc. If the retrieved information comprises images, the apparatus may prepare 519 the images for output by creating an audio description of the image. In either case, the speaker may be part of an in-ear component or otherwise located within earshot of the officer. Thus, without any instruction, request, or command from the officer, the apparatus in that example actively acquires 503 images and videos via a camera, and accesses 511 an information source to search 511 and retrieve 515 matching information such as details related to the acquired images, prepares 519 the retrieved information for output, and provides 523 to the officer audio information about a possible match to persons being sought.

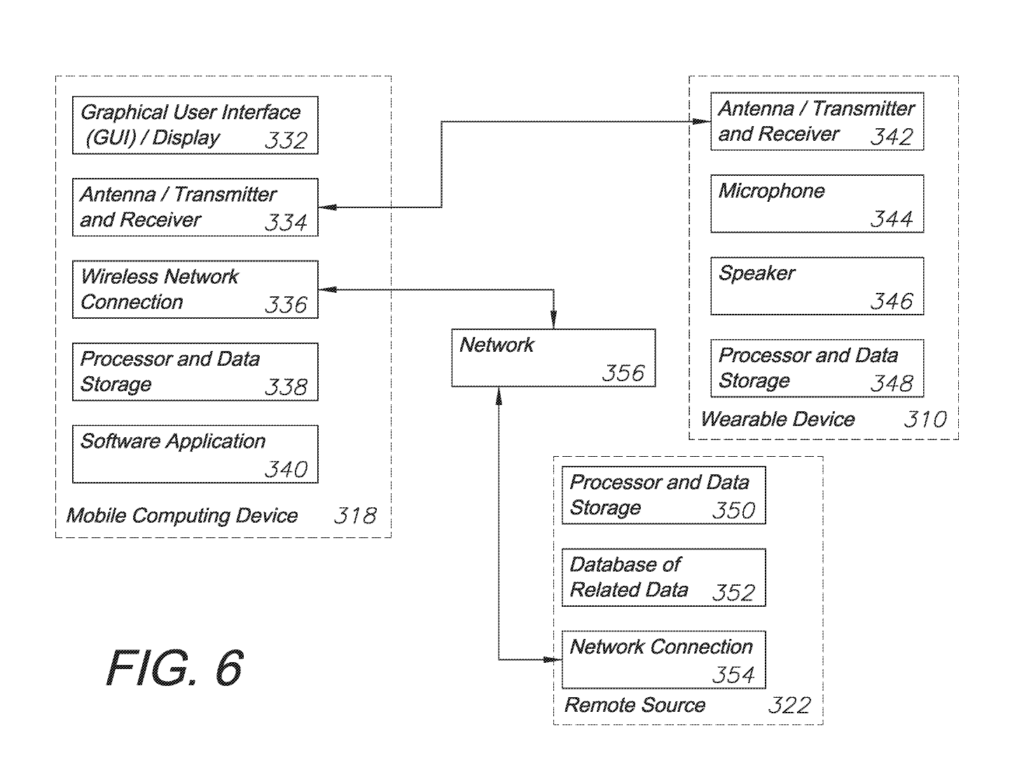

FIG. 6 shows the relationship between a mobile computing device 318, such as a user's handheld computer or smartphone device, an embodiment of the wearable device 310, a remote source 322 for data, and a network 356 for communication between those three elements.

The mobile computing device 318 preferably has a graphical user interface (GUI) display 332, an antenna 334 or other transceiver unit, a wireless network connection 336 for connecting to the network 356, a processor and data storage 338, and a software application 340 operational by the processor with elements viewable on the GUI.

The wearable device 310 includes an antenna 342 or other transceiver unit, a microphone 344, a speaker 346, and a processor and local data storage 348. The wearable device can wirelessly synch with the mobile computer device 318 and uses the mobile computing device to access the network 356. Optionally, the wearable could skip the mobile computing device and have a direct connection with the network, but a preferred embodiment would be set up as shown in FIG. 6.

The remote source 322 is a remote server computer with a processor and data storage 350, database of related data 352, and a network connection 354 for communicating with the mobile computing device.

It should be noted that data is refreshed at regular intervals so that older key information is being replaced with updated key information, and older related data is updated with newer related data, for up to the minute results. The interval of when data refresh needs to occur can be determined by the user or may be automatically determined by the mobile computing device processor or some other processor in the system. Optionally the user could also just determine to refresh data by using the software application on the mobile computing device. This would be important, for example, if the mobile computing device hasn't opened or updated a social media website database in some length of time, ensuring all data is up to date.

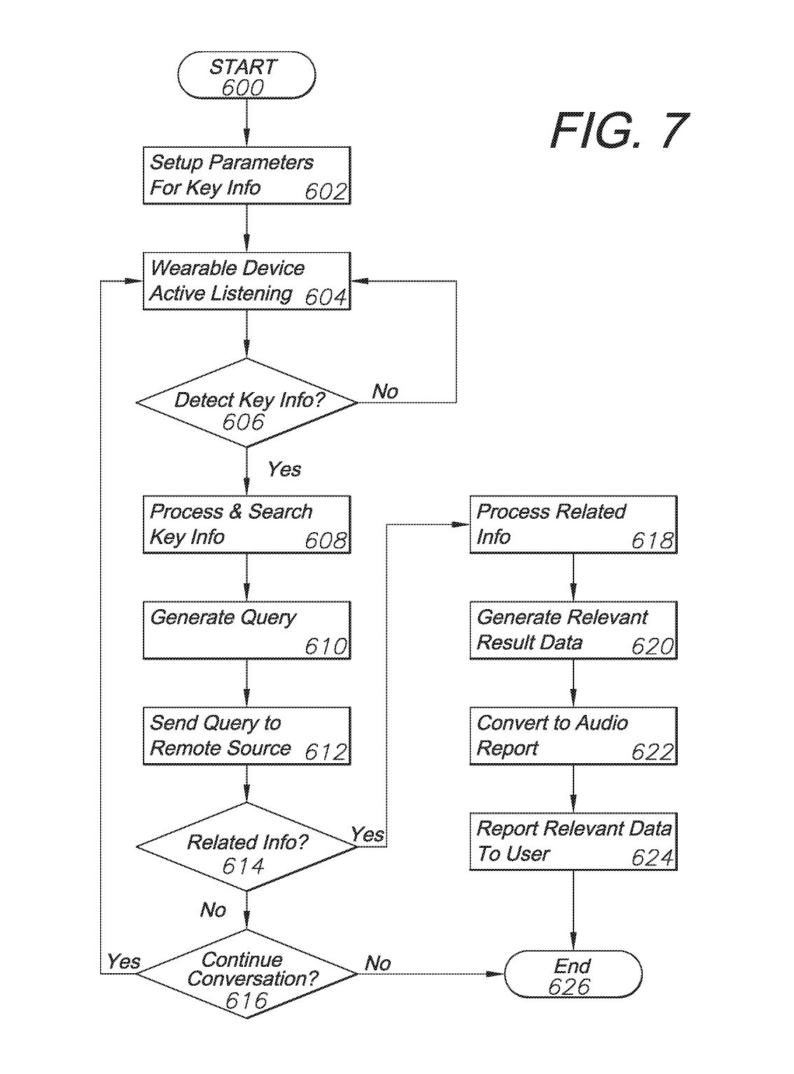

FIG. 7 shows how using these elements in conjunctions may occur in a typical process. Starting at 600, the user will set up parameters for key information at 602. This may include setting up these parameters on the mobile computing device 318, the wearable 310 itself, or through an online profile using another computing device. These parameters would tell the wearable's processor 348 and/or the mobile computing device's processor 338 what type of key information to listen for during a conversation.

At 604, the wearable device is actively listening to pick up on key information. If key information is detected at 606, the wearable instructs the mobile computing device to process and search on that key information at 608. Otherwise active listening continues at 604.

When key information is detected at 606, a query is generated at 610 by the mobile computing device and the query is sent to the remote source at 612. The remote source could be a remote database for a social media website, news website database, or any other potential remote database with data that could be relevant or related to the key information.

If relevant information is found at the remote server at 614, that data is processed at 618. Otherwise, the user may be notified of no related data. If the conversation continues at 616, active listening once again occurs at 604. Otherwise the process ends at 626.

When related information is found at 614 and processed at 618, the system will generate relevant result data at 620 out of that related data. This means that the related data is parsed down and put into a short, meaningful response to report back to the user. That report is converted to audio at 622 and reported to the user using the wearable's speaker at 624. The process then ends at 626 with the user being provided with relevant data derived from key information overheard during the conversation.

The end of the process would signal a refresh of data. Data may also refresh at regular intervals or upon a decision to refresh data selected by the user.

It is to be understood that while certain embodiments and/or aspects of the invention have been shown and described, the invention is not limited thereto and encompasses various other embodiments and aspects.

Having thus described the invention, what is claimed as new and desired to be secured by Letters Patent is:

1. An apparatus for audibly providing information related to key information, the apparatus comprising:
a housing comprising an input and an output, said housing is configured to be wearable proximally to the external auditory canal of a person's ear;
said input comprising at least an audio microphone;
said output comprising at least an audio speaker;
a computer memory containing key information;
a processor configured to:
access a remote memory to search the remote memory for related data to the key information, wherein said remote memory comprises a computer server associated with a database containing said related data; and
retrieve the related data automatically without requiring a command input;
wherein key information is received by said audio microphone and transferred to said processor;
said audio microphone configured to constantly be gathering said key information and said processor configured to constantly be processing said key information and retrieving said related data;
said processor further configured to compare said related data with said key information, thereby generating relevant data; and
wherein said relevant data is at transmitted from said processor to said audio speaker audibly.

2. The apparatus of claim 1, wherein said housing is configured to be connected to a temple portion of a pair of eyeglasses.

3. The apparatus of claim 1 wherein the key information is prepared by applying speech recognition to the key information as received by said audio microphone.

4. The apparatus of claim 1, further comprising:
a camera connected to said processor, said camera configured for actively retrieving visual information; and
wherein the key information partially comprises visual information, and the processor is configured to prepare the visual information by applying pattern recognition to the visual information.

5. The apparatus of claim 1, wherein said processor of said mobile computing device is configured to purge said key information from said data storage and to replace said key information with new key information.

6. The apparatus of claim 5, wherein said processor is configured to purge said key information upon user request.

7. The apparatus of claim 5, wherein said processor is configured to purge said key information upon a pre-determined interval.

8. A method of generating audible data related to key information, the method comprising the steps:
setting parameters for key information retrieval using a mobile computing device comprising a graphical user interface (GUI), data storage, processor, and network connection;
wearing a wearable device, said wearable device comprising a housing, an audio microphone, an audio speaker, a processor, and a wireless connection with said mobile computing device;
providing said parameters for key information to said wearable device processor with said mobile computing device processor via said wireless connection;
actively listening to audible data with said audio speaker;
detecting key information with said audio speaker and transferring said key information to said wearable device processor, thereby transferring said key information to said mobile computing device processor;
connecting said mobile computing device with a remote database stored on a remote computer system via said network connection, said remote computer system comprising a data storage and processor;
searching said remote database based upon said key information;
locating related data stored within said remote database;
reporting said related data from said remote database to said mobile computing device;
extracting relevant data from said related data with said mobile computing device processor;
transforming said relevant data into an audio format;
transferring said relevant data in audio format to said processor of said wearable device; and
audibly playing said relevant data in audio format through said wearable device audio speaker.

9. The method of claim 8 wherein the key information is prepared by applying speech recognition to the key information as received by said audio microphone.

10. The method of claim 8, further comprising the steps:
connecting a camera to said housing and to said wearable device processor, said camera configured for actively retrieving visual information; and
generating said key information at least partially with said mobile computing device processor based upon said visual information wherein the key information partially comprises visual information, and the processor is configured to prepare the visual information by applying pattern recognition to the visual information.

11. The method of claim 8, wherein said remote computer system comprises a social media software platform.

12. The method of claim 8, wherein said remote computer system comprises a news software platform.

13. The method of claim 8, further comprising the steps:
purging said key information from said data storage with said processor of said mobile computing device; and
replacing said key information with new key information from said audio microphone.

14. The apparatus of claim 13, wherein said processor is configured to purge said key information upon user request.

15. The apparatus of claim 13, wherein said processor is configured to purge said key information upon a pre-determined interval.

16. A method of generating audible data related to key information, the method comprising the steps:
setting parameters for key information retrieval;
wearing a wearable device, said wearable device comprising a housing, an audio microphone, an audio speaker, a processor, and a wireless network connection;
actively listening to audible data with said audio speaker;
detecting key information with said audio speaker and transferring said key information to said wearable device processor, thereby transferring said key information to said mobile computing device processor;
connecting said wearable device processor with a remote database stored on a remote computer system via said wireless network connection, said remote computer system comprising a data storage and processor;
searching said remote database based upon said key information;
locating related data stored within said remote database;
reporting said related data from said remote database to said wearable device processor;
extracting relevant data from said related data with said wearable device processor;
transforming said relevant data into an audio format; and
audibly playing said relevant data in audio format through said wearable device audio speaker.

17. The method of claim 16, wherein the key information is prepared by applying speech recognition to the key information as received by said audio microphone.

18. The method of claim 16, further comprising the steps:
connecting a camera to said housing and to said wearable device processor, said camera configured for actively retrieving visual information; and
generating said key information at least partially with said m wearable device processor based upon said visual information wherein the key information partially comprises visual information, and the processor is configured to prepare the visual information by applying pattern recognition to the visual information.

19. The method of claim 16, wherein said remote computer system comprises a social media software platform.

20. The method of claim 16, wherein said remote computer system comprises a news software platform.
